(19) United States
(12) Patent Application Publication
(10) Pub. No.: US 2005/0152439 A1
(43) Pub. Date: Jul. 14, 2005

(54) Interface for digital communication

(75) Inventors: Marcel Beij, Eindhoven (NL); Arnold Willem Buij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL-5621 BA Eindhoven (NL)

(21) Appl. No.: 10/508,452

(22) PCT Filed: Feb. 26, 2003
(86) PCT No.: PCT/IB03/00661

(30) Foreign Application Priority Data
Mar. 26, 2002 (EP) 02076185.4

(51) Int. Cl. H04B 1/38

(52) U.S. Cl. 375/220

(57) ABSTRACT

In a digital interface comprising a current limiter, a reference voltage proportional to the bus voltage is generated and the current limiter is switched on when the incoming digital signal is higher than the reference voltage and switched of when the incoming signal is smaller than the reference voltage. The “high/low-ratio” of the digital signal at the output of the interface is substantially improved by the use of the reference voltage.

The invention relates to an interface for digital communication comprising
input terminals for receiving a first signal comprising a first sequence of digital pulses from a master,
a circuit part I for generating a second signal comprising a second sequence of digital pulses out of the first signal,
output terminals for supplying the second sequence of digital pulses to a slave.

Such an interface is known from a digital interface system that is known as Digital Addressable Lighting Interface (DALI). In the known interface a light emitting diode is coupled between the output terminals and the circuit part I comprises a current limiter. The light emitting diode is part of one or more optocouplers that function as an opto-isolator making it possible for one master to control more than one slave. DALI uses bi-phase encoding pulses. This means that a data bit is built up of a complementary pair of pulses so that every data bit has a “high/low ratio” that is substantially equal to 1. In the known interface the current limiter conducts and limits a current that flows through the light emitting diode when the first signal is high. However, this current has a rise time, being the time interval needed to reach its maximal value, and a fall time, being the time interval needed for the current to decrease from its maximal value to zero. These rise and fall times are strongly influenced by the maximal amplitude of the digital pulses belonging to the first sequence. In practice this maximal amplitude, that is often referred to as the bus voltage, varies very much. An important disadvantage of the known interface is that the combination of rise and fall time, the bus voltage and the opto-isolator change the “high/low ratio” of the signal to such an extent that the second signal is relatively often not recognized as a DALI signal by the slave.

The invention aims to provide an interface that generates a second signal that has a proper “high/low ratio” irrespective of the bus voltage.

An interface as mentioned in the opening paragraph is therefore in accordance with the invention characterized in that the interface further comprises a circuit part II for generating a reference signal that represents the highest amplitude of the digital pulses belonging to the first sequence and for activating circuit part I when the amplitude of the first signal is higher than the reference signal and for deactivating circuit part I when the amplitude of the first signal is lower than the reference signal.

It has been found that the “high/low-ratio” of the second signal generated by an interface according to the invention is very close to “1” irrespective of the bus voltage.

Good results have been obtained for embodiments of an interface according to the invention, wherein the circuit part I comprises a current limiter.

In a preferred embodiment of an interface according to the invention, the circuit part II comprises first unidirectional means and capacitive means for sampling and storing the highest amplitude of the digital pulses belonging to the first sequence. Thus part of the circuit part II is realized in a simple and dependable manner. Preferably the circuit part II additionally comprises a voltage divider and second unidirectional means.

When the interface is meant to enable communication between one master and more than one slave, the interface is preferably further equipped with a light emitting diode coupled between the output terminals.

An embodiment of an interface according to the invention will be explained making reference to a drawing. In the drawing

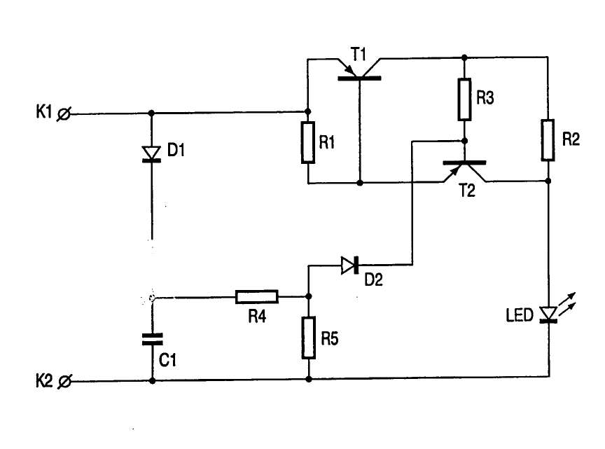

FIG. 1 shows an embodiment of an interface according to the invention.

In FIG. 1, K1 and K2 are input terminals for receiving a first signal comprising a first sequence of digital pulses from a master. Input terminals K1 and K2 are connected by means of a series arrangement of diode D1 and capacitor C1. In this embodiment diode D1 forms first unidirectional means and capacitor C1 forms capacitive means. Together capacitor C1 and diode D1 form means for sampling and storing the highest amplitude of the digital pulses belonging to the first sequence. Capacitor C1 is shunted by a series arrangement of ohmic resistors R4 and R5 that forms a voltage divider. A common terminal of ohmic resistors R4 and R5 is connected to an anode of diode D2 forming second unidirectional means. Input terminals K1 and K2 are also connected by means of a series arrangement of PNP transistor T1, ohmic resistor R2 and light emitting diode LED that forms part of an optocoupler during operation of the interface. The series arrangement of PNP transistor T1 and ohmic resistor R2 is shunted by a series arrangement of ohmic resistor R1 and PNP transistor T2. An emitter of PNP transistor T2 is connected to a basis of PNP transistor T1. A basis of PNP transistor T2 is connected to a first end of ohmic resistor R3 and to a cathode of diode D2. A further end of ohmic resistor R3 is connected to a collector of PNP transistor T1. Ohmic resistors R1, R2 and R3 together with PNP transistors T1 and T2 form a current limiter that functions as a circuit part I for generating a second signal comprising a second sequence of digital pulses out of the first signal. Capacitor C1, ohmic resistors R4 and R5 and diodes D1 and D2 together form a circuit part II for generating a reference signal that represents the highest amplitude of the digital pulses belonging to the first sequence and for activating circuit part I when the amplitude of the first signal is higher than the reference signal and for deactivating circuit part I when the amplitude of the first signal is lower than the reference signal.

The operation of the interface shown in FIG. 1 is as follows.

When the interface is in operation but no communication is taking place, the voltage between input terminals K1 and K2 equals the bus voltage. When a first signal comprising a first sequence of digital pulses is present at the input terminals, the voltage between the input terminals changes between the bus voltage and substantially zero. Capacitor C1 is charged to a voltage that is substantially equal to the bus voltage. Via resistors R4 and R5 and diode D2 a reference signal is generated that is a predetermined fraction of the bus voltage and is present at the basis of PNP transistor T2. As a result the current limiter formed by ohmic resistors R1, R2 and R3 and PNP transistors T1 and T2 will only become conductive when the first signal has an amplitude that is higher than the reference signal and will become non-conductive when the first signal has amplitude that is lower than the reference signal. It is important to note that the reference signal is proportional to the bus voltage and will change when the bus voltage changes. When the current limiter is conductive, a current flows through light emitting diode LED causing the light emitting diode LED to emit light. This light is received by one or more light sensitive cells that form one or more optocouplers together with light emitting diode LED. The current through the LED forms the second signal.

An experiment was conducted in which two interfaces were used. The first interface was a practical embodiment of the interface shown in FIG. 1 while the second interface did not comprise the circuit part II but was otherwise identical to the first interface. The “high/low ratios” of the second signal generated by both interfaces out of the same first signal were measured for different bus voltages. For a bus voltage of 20 V it was found that the first interface generated a second signal with a “high/low-ratio” of 52/48 while the second interface generated a second signal with a “high/low-ratio” of 55/45. For a bus voltage of 16 V the respective “high/low-ratios” were 51/49 and 54/46. For a bus voltage of 8 V the respective “high/low-ratios” were 51/49 and 56/44. It can be concluded that the circuit part II that is present in an interface according to the invention improves the “high/low-ratio” of the second signal substantially for a wide range of bus voltages.

1. Interface for digital communication comprising
input terminals for receiving a first signal comprising a first sequence of digital pulses from a master,
a circuit part I for generating a second signal comprising a second sequence of digital pulses out of the first signal,
output terminals for supplying the second sequence of digital pulses to a slave,
characterized in that the interface further comprises a circuit part II for generating a reference signal that represents the highest amplitude of the digital pulses belonging to the first sequence and for activating circuit part I when the amplitude of the first signal is higher than the reference signal and for deactivating circuit part I when the amplitude of the first signal is lower than the reference signal.

2. Interface according to claim 1, wherein the circuit part I comprises a current limiter.

3. Interface according to claim 1, wherein the circuit part II comprises first unidirectional means and capacitive means for sampling and storing the highest amplitude of the digital pulses belonging to the first sequence.

4. Interface according to claim 3, wherein the circuit part II further comprises a voltage divider and second unidirectional means.

5. Interface according to claim 1, wherein the interface is further equipped with a light emitting diode coupled between the output terminals.
